(19) United States
(12) Patent Application Publication
(10) Pub. No.: US 2025/0282189 A1
(43) Pub. Date: Sep. 11, 2025

(54) Trailer Recovery Plate

(71) Applicant: Jerry Lee Lane, Zanesville, OH (US)

(72) Inventor: Jerry Lee Lane, Zanesville, OH (US)

(21) Appl. No.: 18/600,333

(22) Filed: Mar. 8, 2024

(51) Int. Cl. B60D 1/04; B60D 1/06

(52) U.S. Cl. CPC B60D 1/04; B60D 1/06

(57) ABSTRACT

A fabricated metal plate which allows you to attach a standard 1⅞″, 2″ or 2 5/16″ hitch ball with a 1″ shank and attach to a winch line cable via a hook or shackle. When attached to a standard trailer receiver, the Trailer Recovery Plate will allow you to recover the trailer safely with better adequate control.

### FIELD OF THE DISCLOSURE

This application relates to a steel plate with two specifically shaped holes to assist in recovery of a trailer with standard ball receiver.

### BACKGROUND

In the field of towing, there are times when you must recover a trailer that has become dislodged from a vehicle. You are required to recover it from its point of rest. During recovery while pulling trailer up onto a rollback, the trailer will not pull on direct center and will go sideways. This causes safety issues and the Towing Operator does not have total control of the winching process.

### SUMMARY

By utilizing the Trailer Recovery Plate, this apparatus allows a safe and secure connection and maintains complete control by pulling the trailer with a standard ball receiver on a direct center line during recovery process. Safe control and stability can now be maintained during recovering by utilizing the Trailer Recovery Plate.

### BRIEF DESCRIPTION OF DRAWINGS

FIG. 1: ISO drawing view of a steel plate.

FIG. 2: A perspective view of plate showing connection between winch cable hook and trailer receiving ball hitch.

### DETAILED DESCRIPTION OF DRAWINGS

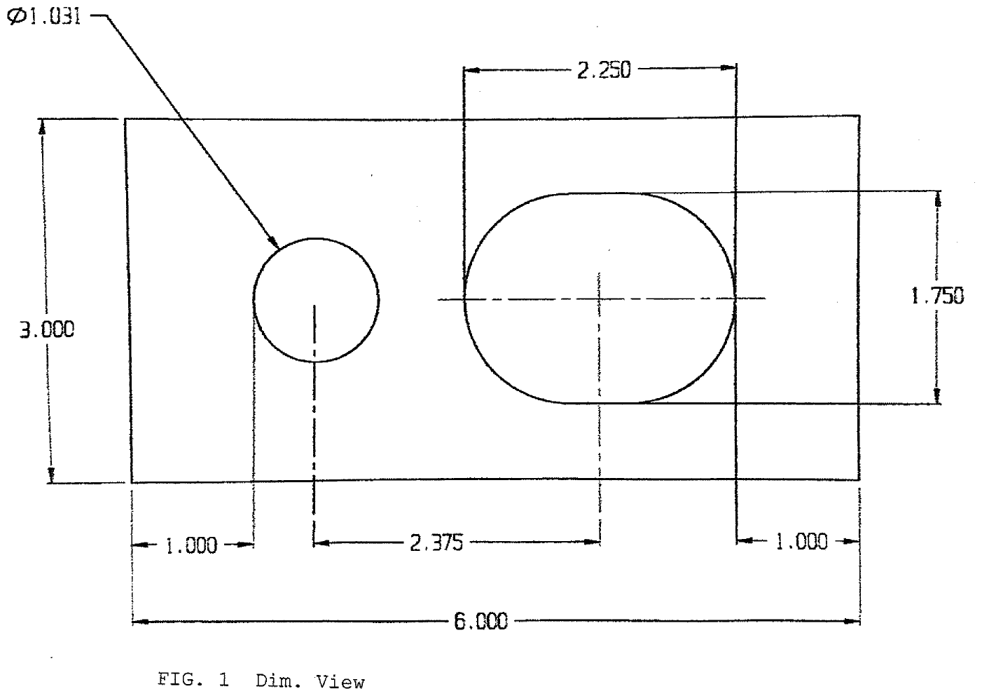

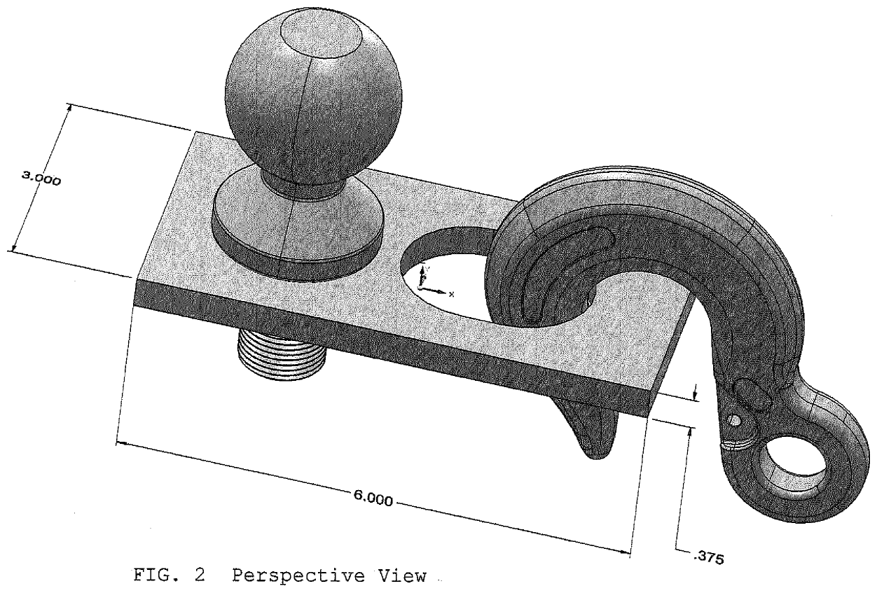

FIG. 1 shows the ISO drawing with plate dimension and hole locations. FIG. 2 shows the plan view of a standard hitch ball using a 1⅞″, 2″ or 2 5/16″ standard hitch ball with 1″ shank and a winch line cable hook applied to the plate.

### DETAILED DESCRIPTION

A steel plate that is designed to accept a standard sized trailer ball into the designated smaller round hole. With the larger elongated hole where a winch cable hook can be attached.

The plate will be made from mild steel with density of 0.282 lb/in² and tensile strength of 58000-798000 psi. The plate fabrication to be completed via the use of a 126-ton iron worker machine with a punch and die.

Fabricated steel plate coupled with a standard hitch ball installed into smaller diameter circular hole. (See FIG. 2). Attach the winch line hook to the completed plate and ball. By utilizing the Trailer Recovery Plate, this apparatus allows a safe and secure connection and maintains complete control by pulling the trailer with a standard ball receiver on a direct center line during recovery process. Safe control and stability can now be maintained during recovering by utilizing the Trailer Recovery Plate. After completing research to date, Mar. 7, 2024, to my knowledge such apparatus does not exist.

1. The invention claimed is a device that maintains center of pull when utilizing a winch cable to recover or extract a trailer with a standard ball receiver.
